(19) United States
(12) Patent Application Publication
(10) Pub. No.: US 2026/0012645 A1
(43) Pub. Date: Jan. 8, 2026

(54) VIDEO CODING WITH DISPLAY OVERLAYS

(71) Applicant: Nokia Technologies Oy, Espoo (FI)

(72) Inventors: Jill BOYCE, Portland, OR (US); Miska Matias HANNUKSELA, Tampere (FI)

(21) Appl. No.: 19/247,062

(22) Filed: Jun. 24, 2025

Related U.S. Application Data
(60) Provisional application No. 63/667,182, filed on Jul. 3, 2024.

(51) Int. Cl. H04N 19/70; H04N 5/265; H04N 19/132; H04N 21/431

(52) U.S. Cl. CPC H04N 19/70; H04N 5/265; H04N 19/132; H04N 21/4316

(57) ABSTRACT

Various embodiments provide methods, apparatuses, and computer program products. An example apparatus includes: at least one processor; and at least one memory storing instructions that, when executed by the at least one processor, cause the apparatus at least to: defining a display overlay information message comprising metadata for enabling two or more display overlays to be coded in pictures in one or more layers within a bitstream; and signaling, in or along the bitstream, the display overlay information message to a receiver.

### TECHNICAL FIELD

The examples and non-limiting embodiments relate generally to multimedia coding and, more particularly to, video coding with display overlays.

### BACKGROUND

It is known provide standardized formats for encoding, signaling, or decoding of media data.

### SUMMARY

Example 1: An apparatus comprising: at least one processor; and at least one memory storing instructions that, when executed by the at least one processor, cause the apparatus at least to: defining a display overlay information message comprising metadata for enabling two or more display overlays to be coded in pictures in one or more layers within a bitstream; and signaling, in or along the bitstream, the display overlay information message to a receiver.
Example 2: The apparatus of example 1, wherein the metadata comprised in the display overlay information message is intended to be used by the receiver to form a target display picture comprising two or more display overlays in a specified order.
Example 3: The apparatus of example 2, wherein one or more higher order display overlays are displayed in front of one or more lower order display overlays.
Example 4: The apparatus of any of the examples 1 to 3, wherein a display overlay comprises a rectangular region comprising texture components.
Example 5: The apparatus of example 4, wherein the rectangular region further comprises alpha components corresponding to the texture components.
Example 6: The apparatus of any of the examples 3 or 4, wherein when an alpha component is not present for a display overlay, pixel values in the target display picture of regions represented by the display overlay replace existing pixel values of a target display overlay that are formed from the one or more lower order display overlays.
Example 7: The apparatus of any of the examples 3 to 5, wherein when the alpha component is present for a display overlay, the alpha component is applied to the higher order display overlay pixel values, with an existing target display picture as the background, to form new pixel values in the target display picture.
Example 8: The apparatus of any of the previous examples, wherein the instructions, when executed by the at least one processor, cause the apparatus at least to perform: coding the two or more display overlays as pictures, subpictures, or constituent rectangles.
Example 9: The apparatus of example 8, wherein the instructions, when executed by the at least one processor, cause the apparatus at least to perform: signaling first syntax elements to determine which of pictures, subpictures, or constituent rectangles are used for coding the two or more display overlays.
Example 10: The apparatus of any of the previous examples, wherein the instructions, when executed by the at least one processor, cause the apparatus at least to perform: defining second syntax elements for identifying a location of each display overlay component in the bitstream and an intended display order of the each display overlay in the target display picture; and signaling, in or along the bitstream, the second syntax elements to the receiver.
Example 11: The apparatus of example 10, wherein the each display overlay component comprises a texture component and/or an alpha component.
Example 12: The apparatus of any of examples 2 to 11, wherein the instructions, when executed by the at least one processor, cause the apparatus at least to perform: signaling, in or along the bitstream, position of each display overlay in the target display picture.
Example 13: The apparatus of any of examples 2 to 11, wherein the instructions, when executed by the at least one processor, cause the apparatus at least to perform: signaling, in or along the bitstream, a resampling ratio for at least one display overlay, wherein the resampling ratio is used by the receiver to derive a size of the at least one display overlay in the target display picture.
Example 14: The apparatus of any of the previous examples, wherein the two or more display overlays coded in separate layers comprise different frame rates.
Example 15: The apparatus of any of the previous examples, wherein the display overlay information message comprises a display overlay information supplemental information message.
Example 16: An apparatus comprising: at least one processor; and at least one memory storing instructions that, when executed by the at least one processor, cause the apparatus at least to: receiving, from or along the bitstream, a display overlay information message comprising metadata that enables two or more display overlays to be coded in one or more layers within the bitstream; decoding the two or more display overlays to generate two or more decoded display overlays; and using the two or more decoded display overlays for forming a target display picture by overlaying the two or more decoded display overlays.
Example 17: The apparatus of example 16, wherein the target display picture comprises a composite formed by applying the two or more decoded display overlays in a specified order.
Example 18: The apparatus of example 17, wherein one or more higher order display overlays are displayed in front of one or more lower order display overlays.
Example 19: The apparatus of any of the examples 16 to 18, wherein a display overlay comprises a rectangular region comprising texture components.
Example 20: The apparatus of example 18, wherein the rectangular region further comprises alpha components corresponding to the texture components.
Example 21: The apparatus of any of the examples 18 or 19, wherein when an alpha component is not present for a display overlay, pixel values in the target display picture of regions represented by the display overlay replace existing pixel values of the target display overlays that are formed from the one or more lower order display overlays.
Example 22: The apparatus of any of the examples 18 to 20, wherein when the alpha component is present for a display overlay, new pixel values in the target display picture are formed by applying the alpha component to the higher order display overlay pixel values with an existing target display picture as the background.
Example 23: The apparatus of example 22, wherein the instructions, when executed by the at least one processor, cause the apparatus at least to perform: applying the alpha components for generating the target display picture.
Example 24: The apparatus of any of the examples 19 to 23, wherein the two or more display overlays are coded as pictures, subpictures, or constituent rectangles.
Example 25: The apparatus of example 24, wherein the instructions, when executed by the at least one processor, cause the apparatus at least to perform: receiving first syntax elements to determine which of pictures, subpictures, or constituent rectangles were used to code the two or more display overlays.
Example 26: The apparatus of any of the examples 16 to 25, wherein the instructions, when executed by the at least one processor, cause the apparatus at least to perform one of the following: using a layer identifier in combination with the subpictures or the constituent rectangles for identifying the two or more display overlays; using the layer identifier for identifying the two or more display overlays; using subpicture parameters to identify the two or more display overlays; or using constituent rectangle parameters for identifying the two or more display overlays.
Example 27: The apparatus of any of the examples 16 to 26, wherein the instructions, when executed by the at least one processor, cause the apparatus at least to perform: receiving, from or along the bitstream, second syntax elements for identifying a location of each display overlay component in the bitstream and an intended display order of the each display overlay in the target display picture.
Example 28: The apparatus of example 27, wherein the each display overlay component comprises a texture component and/or an alpha component.
Example 29: The apparatus of any of examples 16 to 28, wherein the instructions, when executed by the at least one processor, cause the apparatus at least to perform: receiving, from or along the bitstream, position of the each display overlay in the target display picture.
Example 30: The apparatus of any of the examples 16 to 29, wherein the instructions, when executed by the at least one processor, cause the apparatus at least to perform: receiving, from or along the bitstream, a resampling ratio for at least one display overlay; and using the resampling ratio for determining or deriving a size of the at least one display overlay in the target display picture.
Example 31: The apparatus of example 30, wherein the size of the at least one display overlay is determined or derived based on one of the following: a picture height and width; a subpicture height and width; or a constituent rectangle height and width.
Example 32: The apparatus of any of the examples 16 to 31, wherein the two or more display overlays coded in separate layers comprise different frame rates.
Example 33: The apparatus of example 32, wherein the instructions, when executed by the at least one processor, cause the apparatus at least to perform: handling of different frame rates in different layers by repeating previous decoded picture in output order for the constituent rectangles from a layer with missing picture when forming the target display picture.
Example 34: The apparatus of any of the examples 16 to 33, wherein a resolution of the target display picture is set to a resolution of a display overlay of a zeroth layer.
Example 35: The apparatus of any of the examples 16 to 34, wherein the instructions, when executed by the at least one processor, cause the apparatus at least to perform: resampling one or more display overlay components when forming the target display picture.
Example 36: The apparatus of any of the examples 16 to 34, wherein the display overlay information message comprises a display overlay information supplemental information message.
Example 37: The apparatus of any of the examples 16 to 34, wherein the instructions, when executed by the at least one processor, cause the apparatus at least to perform: applying a resampling process to one or more display overlays of the two or more display overlays.
Example 38: A method comprising: defining a display overlay information message comprising metadata for enabling two or more display overlays to be coded in pictures in one or more layers within a bitstream; and signaling, in or along the bitstream, the display overlay information message to a receiver.
Example 39: The method of example 38, wherein the metadata comprised in the display overlay information message is intended to be used by the receiver to form a target display picture comprising two or more display overlays in a specified order.
Example 40: The method of example 39, wherein one or more higher order display overlays are displayed in front of one or more lower order display overlays.
Example 41: The method of any of the examples 38 to 40, wherein a display overlay comprises a rectangular region comprising texture components.
Example 42: The method of example 41, wherein the rectangular region further comprises alpha components corresponding to the texture components.
Example 43: The method of any of the examples 40 or 41, wherein when an alpha component is not present for a display overlay, pixel values in the target display picture of regions represented by the display overlay replace existing pixel values of the target display overlays that are formed from the one or more lower order display overlays.
Example 44: The method of any of the examples 40 to 42, wherein when the alpha component is present for a display overlay, the alpha component is applied to the higher order display overlay pixel values, with an existing target display picture as the background, to form new pixel values in the target display picture.
Example 45: The method of any of the examples 38 to 44 further comprising coding the two or more display overlays as pictures, subpictures, or constituent rectangles.
Example 46: The method of example 45 further comprising: signaling first syntax elements to determine which of the pictures, subpictures, or constituent rectangles are used for coding the two or more display overlays.
Example 47: The method of any of the examples 38 to 46 further comprising: defining second syntax elements for identifying a location of each display overlay component in the bitstream and an intended display order of the each display overlay in the target display picture; and signaling, in or along the bitstream, the second syntax elements to the receiver.
Example 48: The method of example 47, wherein the each display overlay component comprises a texture component and/or an alpha component.
Example 49: The method of any of examples 39 to 48 further comprising: signaling, in or along the bitstream, position of each display overlay in the target display picture.
Example 50: The method of any of examples 39 to 48 further comprising: signaling, in or along the bitstream, a resampling ratio for at least one display overlay, wherein the resampling ratio is used by the receiver to derive a size of the at least one display overlay in the target display picture.
Example 51: The method of any of the examples 38 to 50, wherein two or more display overlays coded in separate layers comprise different frame rates.
Example 52: The method of any of the examples 38 to 51, wherein the display overlay information message comprises a display overlay information supplemental information message.
Example 53: A method comprising: receiving, from or along a bitstream, a display overlay information message comprising metadata that enables two or more display overlays to be coded in one or more layers within the bitstream; decoding the two or more display overlays to generate two or more decoded display overlays; and using the two or more decoded display overlays for forming a target display picture by overlaying the two or more decoded display overlays.
Example 54: The method of example 53, wherein the target display picture comprises a composite formed by applying the two or more decoded display overlays in a specified order.
Example 55: The method of example 54, wherein one or more higher order display overlays are displayed in front of one or more lower order display overlays.
Example 56: The method of any of the examples 53 to 55, wherein a display overlay comprises a rectangular region comprising texture components.
Example 57: The method of example 55, wherein the rectangular region further comprises alpha components corresponding to the texture components.
Example 58: The method of any of the examples 55 or 56, wherein when an alpha component is not present for a display overlay, pixel values in the target display picture of regions represented by the display overlay replace existing pixel values of the target display overlays that are formed from the one or more lower order display overlays.
Example 59: The method of any of the examples 55 to 57, wherein when the alpha component is present for a display overlay, new pixel values in the target display picture are formed by applying the alpha component to the higher order display overlay pixel values with an existing target display picture as the background.
Example 60: The method of example 59 further comprising: applying the alpha components for generating the target display picture.
Example 61: The method of any of the examples 56 to 60, wherein the two or more display overlays are coded as pictures, subpictures, or constituent rectangles.
Example 62: The method of example 61 further comprising: receiving first syntax elements to determine which of the pictures, subpictures, or constituent rectangles were used to code the two or more display overlays.
Example 63: The method of any of the examples 53 to 62 further comprising one of the following: using a layer identifier in combination with the subpictures or the constituent rectangles for identifying the two or more display overlays; using the layer identifier for identifying the two or more display overlays; using subpicture parameters to identify the two or more display overlays; or using constituent rectangle parameters for identifying the two or more display overlays.
Example 64: The method of any of the examples 53 to 63 further comprising receiving, from or along the bitstream, second syntax elements for identifying a location of each display overlay component in the bitstream and an intended display order of the each display overlay in the target display picture.
Example 65: The method of example 64, wherein the each display overlay component comprises a texture component and/or an alpha component.
Example 66: The method of any of examples 53 to 65 further comprising receiving, from or along the bitstream, position each display overlay in the target display picture.
Example 67: The method of any of the examples 53 to 66 further comprising: receiving, from or along the bitstream, a resampling ratio for at least one display overlay; and using the resampling ratio for determining or deriving a size of the at least one display overlay in the target display picture.
Example 68: The method of example 67, wherein a size of the each display overlay is determined or derived based on one of the following: a picture height and width; a subpicture height and width; or a constituent rectangle height and width.
Example 69: The method of any of the examples 53 to 68, wherein two or more display overlays coded in separate layers comprise different frame rates.
Example 70: The method of example 69 further comprising: handling of different frame rates in different layers by repeating previous decoded picture in output order for the constituent rectangles from a layer with missing picture when forming the target display picture.
Example 71: The method of any of the examples 53 to 70, wherein a resolution of the target display picture is set to a resolution of a display overlay of a zeroth layer.
Example 72: The method of any of the examples 53 to 71 further comprising: resampling one or more display overlay components when forming the target display picture.
Example 73: The method of any of the examples 53 to 71, wherein the display overlay information message comprises a display overlay information supplemental information message.
Example 74: The method of any of the examples 53 to 71 further comprising: applying a resampling process to one or more display overlays of the two or more display overlays.
Example 75: An apparatus comprising means for performing methods as described in any of the examples 38 to 52.
Example 76: An apparatus comprising means for performing methods as described in any of the examples 53 to 74.
Example 77: A computer readable medium comprising program instructions for performing methods as described in any of the examples 38 to 52.
Example 78: The computer readable medium of example 77, wherein the computer readable medium comprises non-transitory computer readable medium.
Example 79: A computer readable medium comprising program instructions for performing methods as described in any of the examples 53 to 74.
Example 80: The computer readable medium of example 79, wherein the computer readable medium comprises non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIGS. 5 and 6 illustrate an example usage of the proposed supplementation enhancement information (SEI) message, in accordance with an embodiment.

FIG. 7 shows an alternate way to code the content of FIG. 5 by using a single coded picture, in accordance with another embodiment.

FIG. 8 illustrates an example usage for background replacement, in accordance with an embodiment.

FIG. 9 is an example apparatus, which may be implemented in hardware, and is caused to, implement examples described herein.

FIG. 10 shows a representation of an example of non-volatile memory media used to store instructions that implement the examples described herein.

FIG. 11 is an example method performed with an encoder, based on the examples described herein.

FIG. 12 is another example method performed with an decoder, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):

| | |
|---|---|
| 4CC | four character code |
| 5G | fifth generation cellular network technology |
| 5GC | 5G core network |
| a.k.a. | also known as |
| AVC | advanced video coding |
| CU | coding unit |
| DSP | digital signal processor |
| DU | distributed unit |
| eNB (or | evolved Node B (for example, an LTE base station) |
| eNodeB) | |
| EN-DC | E-UTRA-NR dual connectivity |
| en-gNB or | node providing NR user plane and control plane protocol |
| En-gNB | terminations towards the UE, and acting as secondary |
| | node in EN-DC |
| E-UTRA | evolved universal terrestrial radio access, for example, |
| | the LTE radio access technology |
| F1 or F1-C | interface between CU and DU control interface |
| gNB (or | base station for 5G/NR, for example, a node providing |
| gNodeB) | NR user plane and control plane protocol terminations |
| | towards the UE, and connected via the NG interface to |
| | the 5GC |
| IEC | International Electrotechnical Commission |
| IoT | internet of things |
| ISO | International Organization for Standardization |
| ISOBMFF | ISO base media file format |
| JPEG | joint photographic experts group |
| LTE | long-term evolution |
| mdat | MediaDataBox |
| MIME | Multipurpose Internet Mail Extension |
| MME | mobility management entity |
| moov | MovieBox |
| MP4 | file format for MPEG-4 Part 14 files |
| MPEG | moving picture experts group |
| MPEG-2 | H.222/H.262 as defined by the ITU |
| MPEG-4 | audio and video coding standard for ISO/IEC 14496 |
| ng or NG | new generation |
| ng-eNB or | new generation eNB |
| NG-eNB | |
| NR | new radio (5G radio) |
| N/W or NW | network |
| PDCP | packet data convergence protocol |
| PHY | physical layer |
| PNG | portable network graphics |
| RAN | radio access network |
| RFC | request for comments |
| RLC | radio link control |
| RRC | radio resource control |
| RRH | remote radio head |
| RU | radio unit |
| Rx | receiver |
| SDAP | service data adaptation protocol |
| SGW | serving gateway |
| SMF | session management function |
| SPS | sequence parameter set |
| SVC | scalable video coding |
| S1 | interface between eNodeBs and the EPC |
| trak | TrackBox |
| Tx | transmitter |
| UE | user equipment |
| UICC | Universal Integrated Circuit Card |
| UPF | user plane function |
| URL | uniform resource locator |
| X2 | interconnecting interface between two eNodeBs in LTE |
| | network |
| Xn | interface between two NG-RAN nodes |

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for video coding with display overlays.

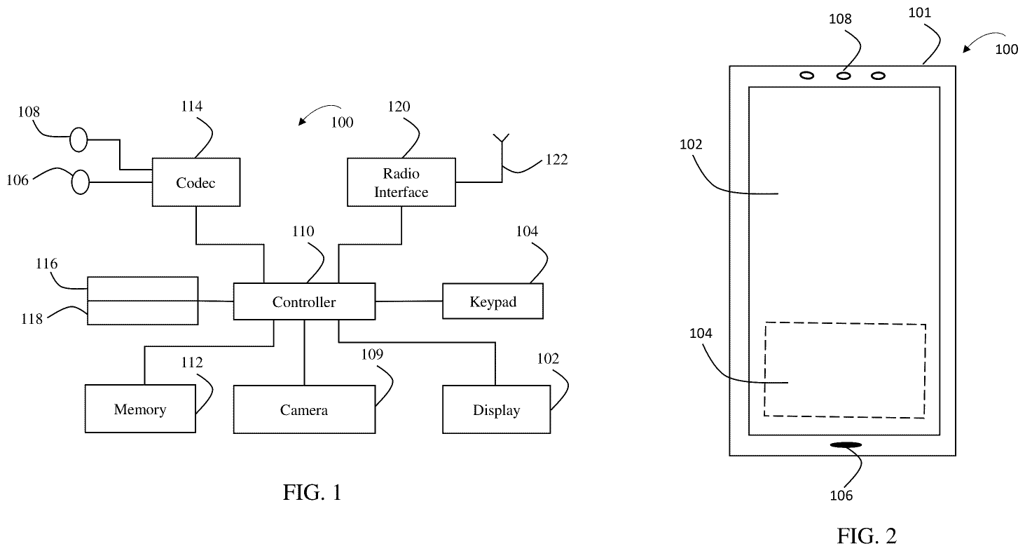

The following describes in detail a suitable apparatus and possible method for video coding with display overlays according to embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

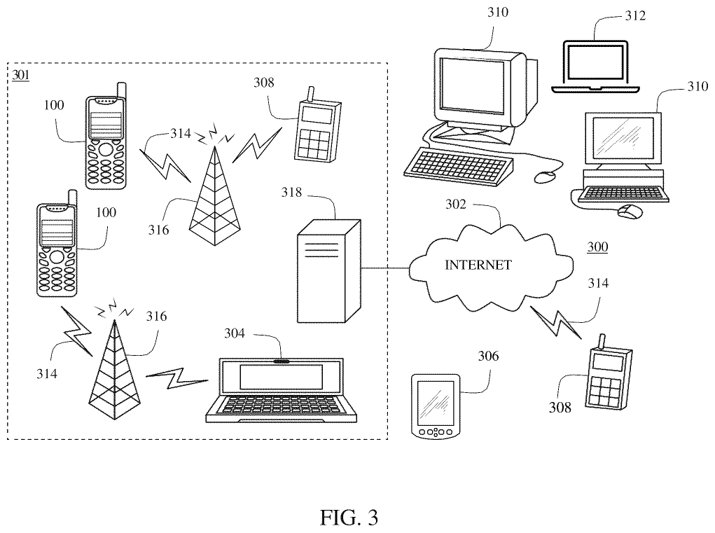

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

An identifier may be defined as a syntax element that identifies a syntax structure. A value of the identifier may for example differ in different instances of the same syntax structure, such as a parameter set. A particular instance of the syntax structure may be referenced through its identifier value. For example, a parameter set that is referenced by the (de)coding of a coded video slice may be identified by providing the identifier value of the parameter set in a header of the coded video slice.

An indicator (idc) may be defined as a syntax element whose value indicates a selection among more than two values (for which semantics have been specified). An indicator syntax element may have _idc postfix in its name.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of an encoder and the input of a decoder, respectively, may be a Network Abstraction Layer (NAL) unit. For transport over packet-oriented networks or storage into structured files, NAL units may be encapsulated into packets or similar structures. A bytestream format has been specified in some video coding standards for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. In some coding standards, the NAL unit header indicates the type of the NAL unit. In some coding standards, the NAL unit header indicates a scalability layer identifier (e.g., called nuh_layer_id), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

Bitstreams or coded video sequences may be encoded to be temporally scalable as follows. Each picture may be assigned to a particular temporal sub-layer. A temporal sub-layer may be equivalently called a sub-layer, temporal sublayer, sublayer, or temporal level. Temporal sub-layers may be enumerated, e.g., from 0 upwards. The lowest temporal sub-layer, sub-layer 0, may be decoded independently. Pictures at temporal sub-layer 1 may be predicted from reconstructed pictures at temporal sub-layers 0 and 1. Pictures at temporal sub-layer 2 may be predicted from reconstructed pictures at temporal sub-layers 0, 1, and 2, and so on. In other words, a picture at temporal sub-layer N does not use any picture at temporal sub-layer greater than N as a reference for inter prediction. The bitstream created by excluding all pictures greater than or equal to a selected sub-layer value and including pictures remains conforming.

Each picture of a temporally scalable bitstream may be assigned with a temporal identifier (also known as TID, temporal layer identifier, sub-layer identifier, sublayer identifier, temporal sub-layer identifier, temporal sublayer identifier, or temporal layer ID), which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference. In some video coding standards, a sub-layer or a temporal sub-layer may be defined to be a temporal scalable layer (or a temporal layer, TL) of a temporal scalable bitstream, consisting of VCL NAL units with a particular value of the TemporalId variable and the associated non-VCL NAL units.

NAL units can be categorized into Video Coding Layer (VCL) NAL units and non-VCL NAL units. VCL NAL units are typically coded slice NAL units.

A non-VCL NAL unit may be for example one of the following types: a video parameter set (VPS), a sequence parameter set (SPS), a picture parameter set (PPS), a supplemental enhancement information (SEI) NAL unit, an access unit delimiter, an end of sequence (EOS) NAL unit, an end of bitstream (EOB) NAL unit, or a filler data NAL unit. Parameter sets may be needed for the reconstruction of decoded pictures, whereas many of the other non-VCL NAL units may not be necessary for the reconstruction of decoded sample values.

A coded picture may be defined as a coded representation of a picture.

In some coding formats, picture unit (PU) may be defined as a set of data units, such as NAL units, that are associated with each other, are consecutive in decoding order, and contain exactly one coded picture. For example, certain non-video-coding data units, such as non-VCL NAL units, may be next to coded video data units in decoding order and the respective picture unit may comprise both these non-video-coding data units and the video coding data units of a coded picture.

In some coding formats, an access unit (AU) may be defined as a set of NAL units that are associated with each other according to a specified classification rule, are consecutive in decoding order, and include at most one coded picture at any scalability layer (e.g., with any specific value of nuh_layer_id in some coding formats, such as HEVC or VVC). In some coding formats, an access unit comprises one or more complete picture units. In some coding formats, in addition to including the VCL NAL units of a coded picture, an access unit may also include non-VCL NAL units associated with the coded picture. Said specified classification rule may, for example, associate pictures with the same output time or picture order count value into the same access unit.

In some coding formats, a coded video sequence (CVS) may be defined as a sequence of coded pictures in decoding order that is independently decodable and is followed by another coded video sequence or the end of the bitstream.

In some coding formats, such as AV1, a coded video sequence comprises one or more temporal units. A temporal unit consists of a series of OBUs starting from a temporal delimiter, optional sequence headers, optional metadata OBUs, a sequence of one or more frame headers, each followed by zero or more tile group OBUs as well as optional padding OBUs. A temporal unit may be defined to comprise all the OBUs that are associated with a specific, distinct time instant. A temporal unit may comprise a temporal delimiter OBU, and all the OBUs that follow, up to but not including the next temporal delimiter. A temporal delimiter OBU may be defined as an indication that the following OBUs will have a different presentation/decoding time stamp from the one of the last frame prior to the temporal delimiter.

A coded layer video sequence (CLVS) may be defined as a sequence of pictures and associated other data within the same scalable layer (e.g., with the same value of nuh_layer_id) that is decodable independently of other pictures in the same layer.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which may not be required for the decoding of output pictures but may assist in related processes, such as picture output timing, post-processing of decoded pictures, rendering, error detection, error concealment, and resource reservation.

Several SEI messages have been specified in various standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata. A metadata OBU may be understood to be similar to an SEI NAL unit or an SEI message.

ITU-T Recommendation T.35 specifies a mechanism to register metadata structures that are identified by a country code, a terminal provider code, and a terminal provider oriented code. ITU-T T.35 metadata starts with the country code, which is followed by the payload registered as specified in ITU-T Recommendation T.35. The ITU-T T.35 terminal provider code and terminal provider oriented code shall be contained in the first one or more bytes of the payload, in the format specified by the Administration that issued the terminal provider code. Any remaining payload data shall be data having syntax and semantics as specified by the entity identified by the ITU-T T.35 country code and terminal provider code. ITU-T T.35 metadata may be carried, for example, in an SEI message or metadata OBU.

Scalable video coding may refer to coding structure where one bitstream may include multiple representations of the content, for example, at different bitrates, resolutions or frame rates. In these cases the receiver can extract the desired representation depending on its characteristics (e.g., resolution that matches best the display device). Alternatively, a server or a network element may extract the portions of the bitstream to be transmitted to the receiver depending on, e.g., the network characteristics or processing capabilities of the receiver. A meaningful decoded representation may be produced by decoding only certain parts of a scalable bitstream. A scalable bitstream typically include of a ‘base layer’ providing the lowest quality video available and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

A scalable bitstream may include a ‘base layer’ providing the lowest quality video available and one or more enhancement layers that enhance the video quality when received and decoded together with the lower layers. In order to improve coding efficiency for the enhancement layers, the coded representation of that layer may depend on the lower layers. E.g., the motion and mode information of the enhancement layer may be predicted from lower layers. Similarly, the pixel data of the lower layers can be used to create prediction for the enhancement layer.

A scalable video codec for quality scalability (also known as signal-to-noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use, e.g., with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

It needs to be understood that the description of scalable video coding may be generalized to any scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the decoded picture buffer (DPB). An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, when any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g., sample values or motion vectors) of reference pictures from a different layer than the layer of the current picture (being encoded or decoded). Many types of inter-layer prediction exist and may be applied in a scalable video encoder/decoder.

The types of inter-layer prediction may comprise, but are not limited to, one or more of the following: inter-layer sample prediction, inter-layer motion prediction, inter-layer residual prediction. In inter-layer sample prediction, at least a subset of the reconstructed sample values of a source picture for inter-layer prediction are used as a reference for predicting sample values of the current picture. In inter-layer motion prediction, at least a subset of the motion vectors of a source picture for inter-layer prediction are used as a reference for predicting motion vectors of the current picture. Typically, predicting information on which reference pictures are associated with the motion vectors is also included in inter-layer motion prediction. For example, the reference indices of reference pictures for the motion vectors may be inter-layer predicted and/or the picture order count or any other identification of a reference picture may be inter-layer predicted. In some cases, inter-layer motion prediction may also comprise prediction of block coding mode, header information, block partitioning, and/or other similar parameters. In some cases, coding parameter prediction, such as inter-layer prediction of block partitioning, may be regarded as another type of inter-layer prediction. In inter-layer residual prediction, the prediction error or residual of selected blocks of a source picture for inter-layer prediction is used for predicting the current picture.

A direct reference layer may be defined as a layer that may be used for inter-layer prediction of another layer for which the layer is the direct reference layer. A direct predicted layer may be defined as a layer for which another layer is a direct reference layer. An indirect reference layer may be defined as a layer that is not a direct reference layer of a second layer but is a direct reference layer of a third layer that is a direct reference layer or indirect reference layer of a direct reference layer of the second layer for which the layer is the indirect reference layer. An indirect predicted layer may be defined as a layer for which another layer is an indirect reference layer. A dependent layer may be a directed predicted layer or an indirect predicted layer. An independent layer may be defined as a layer that does not have direct reference layers. In other words, an independent layer is not predicted using inter-layer prediction. A non-base layer may be defined as any other layer than the base layer, and the base layer may be defined as the lowest layer in the bitstream. An independent non-base layer may be defined as a layer that is both an independent layer and a non-base layer.

A multi-layer bitstream is a bitstream comprising multiple layers, which may be, but are not limited to, base and enhancement layers as discussed above for scalable video coding. A multi-layer bitstream may additionally or alternatively comprise independent layers that do not have inter-layer prediction relationship between each other and may even represent different types of content. Any multi-layer bitstream may be regarded as a scalable video bitstream.

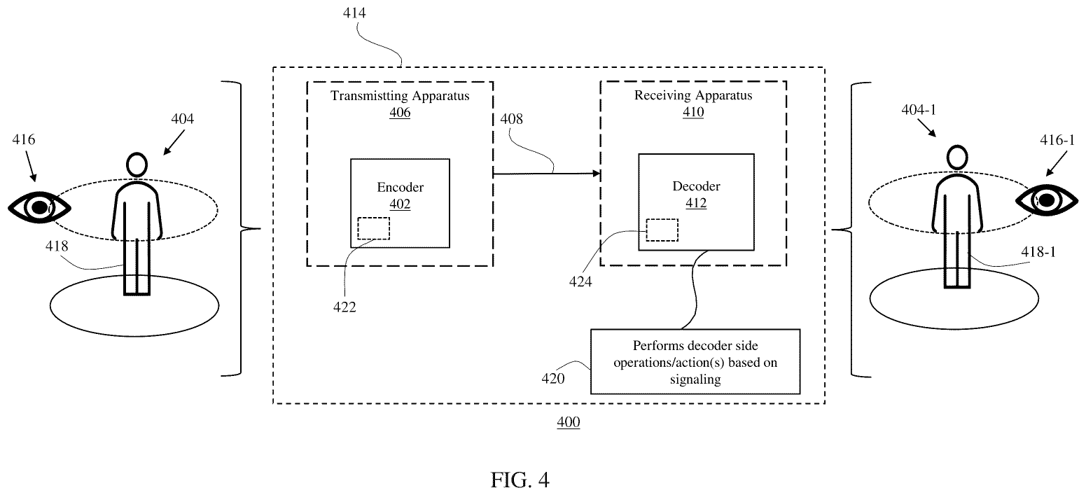

FIG. 4 is a block diagram illustrating a system or apparatus 400 in accordance with several examples. In an example, the encoder 402 is used to encode an image or video from the scene 404, and the encoder 402 is implemented in a transmitting apparatus 406. The encoder 402 produces a bitstream 408 comprising signaling that is received by the receiving apparatus 410, which implements a decoder 412. The encoder 402 sends the bitstream 408 that comprises the herein described signaling. The decoder 412 forms the image or video for the scene 404-1, and the receiving apparatus 410 would present this to the user, e.g., via a smartphone, television, or projector among many other options.

In some examples, the transmitting apparatus 406 and the receiving apparatus 410 are at least partially within a common apparatus, and for example, are located within a common housing 414. In other examples the transmitting apparatus 406 and the receiving apparatus 410 are at least partially not within a common apparatus and have at least partially different housings. Therefore in some examples, the encoder 402 and the decoder 412 are at least partially within a common apparatus, and for example are located within a common housing 414. For example, the common apparatus comprising the encoder 402 and decoder 412 implements a codec. In other examples, the encoder 402 and the decoder 412 are at least partially not within a common apparatus and have at least partially different housings, but when together still implement a codec.

In some examples, 3D media from the capture (e.g., volumetric capture) at a viewpoint 416 of the scene 404, which includes a person 418) is converted via projection to a series of 2D representations with occupancy, geometry, attributes and/or displacements. Additional atlas information is also included in the bitstream to enable inverse reconstruction. For decoding, the received bitstream 408 is separated into its components with atlas information; occupancy, geometry, displacement, and attribute 2D representations. A 3D reconstruction is performed to reconstruct the scene 404-1 created looking at the viewpoint 416-1 with a “reconstructed” person 418-1. The “−1” are used to indicate that these are reconstructions of the original. As indicated at 420, the decoder 412 performs an operation(s) or action(s) based on the received signaling.

Encoding 422 performs encoding of display overlays, a picture, a subpicture, or a constituent rectangle based on the examples described herein. Decoding 424 performs decoding of display overlays, a picture, a subpicture, or a constituent rectangle, based on the examples described herein.

Constituent rectangles (CRs) are rectangular regions within a coded picture, for which their size and position is signaled. A constituent rectangle type may signaled, such as texture, alpha, or depth. In an example, the texture may include a regular video. Additionally or alternative, the texture may be referred to as color. A constituent rectangle type identifier may be signaled, or its value may be inferred the index order.

The constituent rectangles supplemental enhancement information (SEI) messages may use subpicture parameters to identify the size and position of CRs to save bitrate, but use of subpictures is not required. Subpictures have normative encoder/decoder behaviors, while the constituent rectangles SEI, like other SEI messages, doesn't have any normative impact, but can be used for post-processing.

Having thus introduced a suitable but non-limiting technical context for the practice of the example embodiments of the present disclosure, example embodiments will now be described in detail.

The high efficiency video coding (HEVC) and versatile video coding (VVC) standards enable multi-layer coding. A layer ID value signaled in a Network Abstraction Layer (NAL) unit header is used to identify a layer. Layers may be coded using inter-layer prediction or may be independently coded, e.g., without using inter-layer prediction. Auxiliary pictures may be coded in a separate layer from an associated primary picture layer.

In some video coding formats, such as VVC, a subpicture may be defined as a rectangular region of one or more slices within a picture, wherein the one or more slices are complete. Thus, a subpicture includes one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices. One or both of the following conditions may be required to be fulfilled for each subpicture and tile: i) all CTUs in a subpicture belong to the same tile; ii) All CTUs in a tile belong to the same subpicture.

An independent VVC subpicture is treated like a picture in the VVC decoding process. When the motion compensation would reference a sample location outside of boundaries of an independent VVC subpicture, the sample location is saturated to be within the subpicture. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A scalable nesting SEI message contains one or more SEI messages. The SEI messages contained in the scalable nesting SEI message are also referred to as the scalable-nested SEI messages. A scalable nesting SEI message comprises information indicative of which subset of the bitstream the scalable-nested SEI messages apply. For example, VVC includes a scalable nesting (SN) SEI message, which provides information to associate scalable-nested SEI messages with specific output layer sets (OLSs), specific layers, or specific sets of subpictures.

HEVC has an overlay info SEI message. This message is not included in VSEI. The HEVC message differs from the proposed SEI message in several respects.

In the HEVC overlay info SEI message, in addition to the primary layer, two or three additional auxiliary layers are coded. The first auxiliary layer contains all overlay elements in the position where they will appear in a final pictures. The second auxiliary layer contains a label map, in which sample values are used to identify particular overlay elements. The third auxiliary layer is an optional alpha channel.

The multiplane image information (MPII) SEI message has been proposed for inclusion in VSEI and is included in the Technologies Under Consideration for VSEI in JVET-AG2032. The MPII SEI message specifies multiplane image (MPI) scene representation information that may be used for view synthesis.

The MPII SEI message enables signaling texture and opacity for multiple layers, with depth signaled per layer. All layers are the same size and are interleaved within a single layer.

Hannuksela et al., U.S. Pat. No. 10,123,027, proposes to embed some usability information to the video bitstream indicating the intended display behavior when more than one layer is used and associated display behavior using this information, which is hereby incorporated herein by reference in its entirety.

Video content frequently includes a composition of camera-captured content and overlay graphics. Typically, overlay composition is performed before video is encoded for broadcast, streaming, or storage, which causes the overlaid portions of the original camera-capture content to be lost.

When individual display overlay layers were available to a media aware network element (MANE) or a decoder, new capabilities are enabled. For example, to support multiple languages with onscreen titles, text overlays may be included in a display overlay in a separate layer than the main video content, allowing replacement of titles for different languages while avoiding the need to re-encode the main video content. Video decoder/players can enable/disable display of individual overlays.

VVC can be used to code video and alpha channels as separate layers in a multi-layer bitstream, but it does not provide syntax to define how to form an intended display picture utilizing multiple display overlays.

HEVC provides an overlay info SEI message, which has limitations and has not been widely deployed or adopted into VVC or VSEI.

The proposed display overlay information (DOI) SEI message enables multiple display overlays to be coded within the same video bitstream and composed at the decoder/receiver. A target picture may be formed from the decoded display overlays, where a composite is formed by applying display overlays in a specified order. In some embodiments, a target picture may be referred to as a target display picture or vise-versa.

A ‘display overlay’ is a rectangular region of texture samples and optional corresponding alpha channel samples, referred to as the texture component and alpha component, respectively. For the purposes of the SEI message, even a background or ‘base’ display layer is considered to be a display overlay.

In the target picture, the display overlays with a higher order are displayed in front of the display overlays with a lower order. When no alpha component is present, the pixel values in the target picture of regions represented by the higher order display overlay replace the existing pixel values of the target picture, that had been formed from lower order display overlay(s). When an alpha component is present, the new pixel values in the target picture are formed by applying the alpha channel to the higher order display overlay pixel values with the existing target picture as the background.

Each display overlay component may be coded as a picture, a subpicture, or a constituent rectangle in a single layer or multi-layer coded video sequence (CVS). SEI message syntax elements are used to identify the location of the display overlay component in the coded video and its intended display order and display location in a target display picture.

One or more embodiments support resampling of individual display overlays. For example, information may optionally be signaled in the SEI message to indicate resampling information for each individual display overlay, so that when the target display picture is formed, individual components may be resampled with different scaling factors or not resampled.

The proposed SEI message design provides flexibility, allowing encoders to decide how to address specific use cases.

A display overlay information (DOI) message enables multiple display overlays to be coded within the same video bitstream and composed at the decoder/receiver. A ‘display overlay’ is a rectangular region of texture samples and optional corresponding alpha channel samples, referred to as the texture component and alpha component, respectively. The term ‘display overlay’ is used instead of ‘layer’, in an attempt to minimize confusion with layers in a video bitstream which have a particular nuh_layer_id value. For the purposes of the SEI message, even a background or ‘base’ display layer is considered to be a display overlay.

Each display overlay component may be coded as a picture, a subpicture, or a constituent rectangle in a single layer or multi-layer CVS. SEI message syntax elements are used to identify the location of the display overlay component in the coded video and its intended display order and display location in a target display picture.

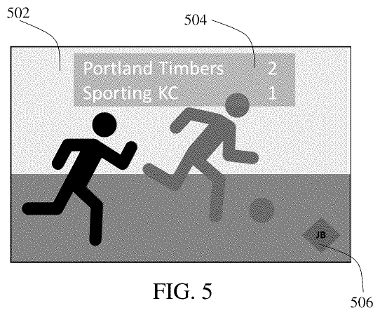

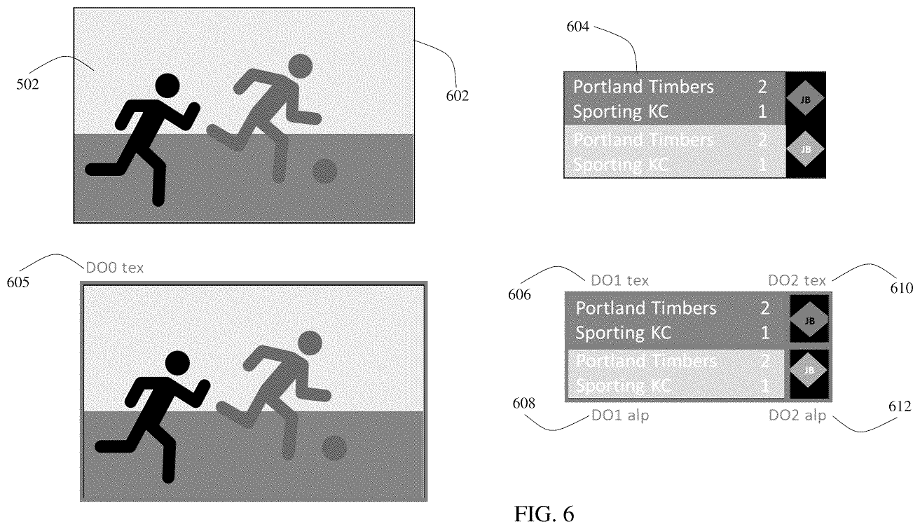

FIGS. 5 and 6 illustrate an example usage of the proposed SEI message, in accordance with an embodiment. For this example, there are 3 display overlays, e.g., 502, 504, and 506. FIG. 5 shows the target display picture, which includes the 3 display overlays: a sports scene 502, a scoreboard overlay 504, and a broadcast station logo overlay 506. FIG. 6 shows what is coded in the bitstream. The 0-th display overlay 602 includes the ‘background’ video content, e.g., the sports scene 502, which is coded as a picture in layer 0 and includes overly 0 texture picture 605, and does not have an alpha channel. A coded layer 1 picture 604 includes both the second and third display overlays, e.g., the scoreboard overlay 504 and the broadcast station logo overlay 506. Both the display overlays in the coded layer 1 picture include an alpha channel, for a total of 4 components. The 4 components in layer 1 are coded as subpictures or constituent rectangles of a picture. For example, a display overlay 1 texture (DO1 tex) 606, a display overlay 1 alpha (DO1 alp) 608, a display overlay 2 texture (DO2 tex) 610, and a display overlay 2 alpha (DO2 alp) 612.

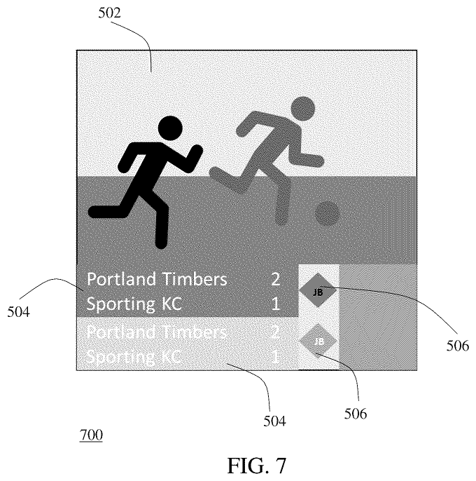

FIG. 7 shows an alternate way to code the content of FIG. 5 by using a single coded picture 700, in accordance with another embodiment. The single coded picture 700 includes 5 components (e.g., 605, 606, 608, 610, and 612) of the 3 display overlays (e.g., 502, 504, and 506).

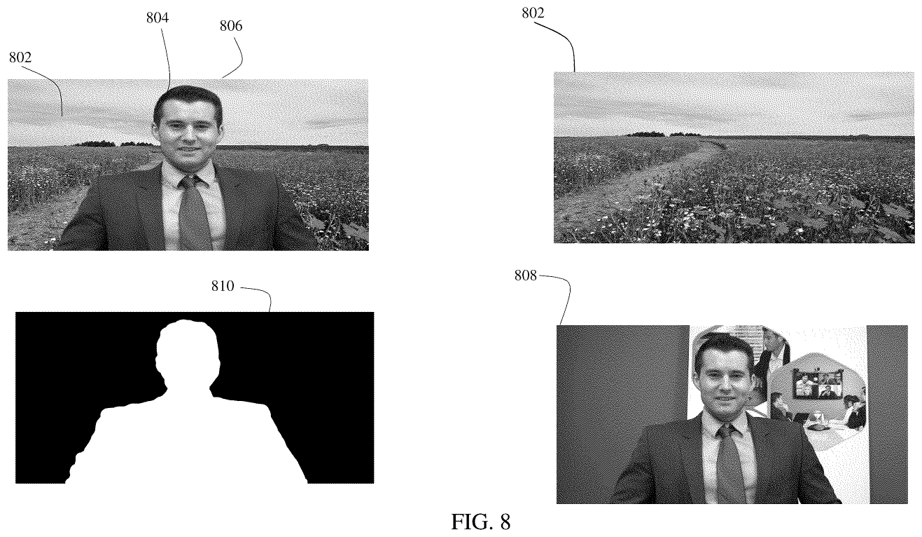

FIG. 8 illustrates an example usage for background replacement, in accordance with an embodiment. In this embodiment two display overlays, representing the background, e.g., a virtual background 802 and foreground, e.g., a person 804 are used. FIG. 8 shows a target display picture 806, in which the person 804 is shown in front of a virtual background 802. The virtual background 802, may be a static or a dynamic background, e.g. a background image or a background video. The virtual background 802, e.g., an image/video, coded in layer 0. The foreground texture component 808 is coded in layer 1. The foreground alpha component 810 is coded in layer 2. In an example, the layer with the person 804 may be coded at full resolution, while the layer with the virtual background 802 may be coded at ¼ resolution which is resampled when forming the target display picture 806.

VSEI Syntax

| | De- |
|---|---|
| | scrip- |
| | tor |
| display_overlays_info( payloadSize ) { | |
| doi_id | u(6) |
| doi_cancel_flag | u(1) |
| if( !doi_cancel_flag ) { | |
| doi_persistence_flag | u(1) |
| doi_num_display_overlays_minus2 | ue(v) |
| doi_nuh_layer_id_present_flag | u(1) |
| doi_pic_partition_flag | u(1) |
| if( doi_pic_partition_flag ) { | |
| doi_partition_type_flag | u(1) |
| doi_partition_id_len_minus1 | u(4) |
| } | |
| doi_offset_params_present_flag | u(1) |
| if( doi_offset_params_present_flag ) | |
| doi_offset_param_length_minus1 | u(4) |
| doi_resampling_enabled_flag | u(1) |
| if( doi_resampling_enabled_flag ) | |
| doi_size_param_length_minus1 | u(4) |
| for( i = 0; i < doi_num_display_layers_minus2 + 2; i++ ) { | |
| if ( doi_nuh_layer_id_present_flag ) | |
| doi_nuh_layer_id[ i ] | u(6) |
| if ( doi_pic_partition_flag ) | |
| doi_partition_id[ i ] | u(v) |
| doi_alpha_present_flag[ i ] | u(1) |
| if ( doi_alpha_present_flag[ i ] ) { | |
| if (doi_nuh_layer_id_present_flag) | |
| doi_alpha_nuh_layer_id[ i ] | u(6) |
| if (doi_rect_id_present_flag) | |
| doi_alpha_partition_id[ i ] | u(v) |
| } | |
| if( i > 0 ) { | |
| if (doi_offset_params_present_flag ) { | |
| doi_top_left_x[ i ] | u(v) |
| doi_top_left_y[ i ] | u(v) |
| } | |
| if( doi_resampling_enabling_flag ) { | |
| doi_width_minus1 [ i ] | u(v) |
| doi_height_minus1[ i ] | u(v) |
| } | |
| } | |
| } | |
| } | |
| } | |

### VSEI Semantics

The display overlays information (DOI) SEI message provides metadata to enable formation of a target display picture formed by overlaying multiple ordered display overlays in a specified order. A display overlay includes texture and optionally an alpha channel, each included within a cropped decoded picture, a subpicture, and/or a constituent rectangle.

Use of the DOI SEI message requires the definition of the following variables, where i is the layer identifier of a layer that may be present in the current CVS:
An array of picture width and picture height in units of luma samples, denoted herein by PicWidthInLumaSamples[i] and PicHeightInLumaSamples[i], respectively.
A chroma format indicator, denoted herein by ChromaFormatIdc, as described in ‘VVC Semantics’.
An array of subpicture counts, denoted by NumSubpics[i].
Arrays of the width and height of the subpictures, denoted herein by SubPicWidth[i][j] and SubPicHeight[i][j] respectively, where j is the subpicture index in 0 . . . NumSubpics[i]−1.

doi_id specifies an identifier of the DOI SEI message.

doi_cancel_flag equal to 1 indicates that the SEI message cancels the persistence of any previous DOI SEI message with the same doi_id in output order. doi_cancel_flag equal to 0 indicates that display overlays information follows.

doi_persistence_flag specifies the persistence of the DOI SEI message for the CVS.

doi_persistence_flag equal to 0 specifies that the DOI SEI message applies to the current access unit (AU) only.

doi_persistence_idc equal to 1 specifies that the DOI SEI message applies to the current AU and persists for all subsequent AUs in output order until one or more of the following conditions are true:
A new CVS begins;
The bitstream ends; or
A picture in the current AU with a DOI SEI message with the same value of doi_id is output that follows the current picture in output order.

doi_num_display_overlays_minus2 plus 2 specifies the number of display overlays for which information is signaled in the SEI message. The value of doi_num_display_overlays_minus2 shall be in the range of 0 to 30, inclusive.

doi_nuh_layer_id_present_flag equal to 1 specifies that the doi_nuh_layer_id[i] syntax element is present in the SEI message. doi_nuh_layer_id_present_flag equal to 0 specifies that the doi_nuh_layer_id[i] syntax element is not present in the SEI message.

doi_pic_partition_flag equal to 1 specifies that display overlay components are coded as constituent rectangles or subpictures. doi_pic_partition_flag equal to 0 specifies that display overlay components are coded as pictures.

It is a bitstream conformance that at least one of doi_nuh_layer_id_present_flag or doi_pic_partition_flag shall be equal to 1.

doi_partition_type_flag equal to 1 specifies that a display overlay component is coded as a constituent rectangle. doi_partition_type_flag equal to 0 specifies that a display overlay component is coded as a subpicture.

When doi_partition_type_flag equal to 1, it is a requirement of bitstream conformance that there is a constituent rectangles SEI message preceding the DOI SEI message in decoding order in the current PU.

doi_partition_id_len_minus1+1 specifies the length of the doi_rect_id[i] and doi_subpic_id[i] syntax elements.

doi_offset_params_present_flag[i] equal to 1 specifies that offset parameters are present for the i-th display overlay. doi_offset_params_present_flag[i] equal to 0 specifies that offset parameters are not present for the i-th display overlay.

doi_offset_param_length_minus1 plus 1 specifies the length of the doi_top_left_x[i] and doi_top_left_y[i], syntax elements in bits.

doi_resampling_enabled_flag equal to 1 specifies that display overlay components may be resampled in the target display picture. doi_resampling_enabled_flag equal to 0 specifies that display overlay components are not resampled in the target display picture.

doi_size_param_length_minus1 plus 1 specifies the length of the doi_width_minus1[i] and doi_height_minus1[i] syntax elements in bits.

doi_nuh_layer_id[i], when present, specifies the layer identifier of the texture component of the i-th display overlay. When not present, the value of doi_nuh_layer_id[i] is inferred to be equal to the layer identifier of the PU containing the DOI SEI message.

When the DOI SEI message is present in any layer in the current AU, it is a requirement of bitstream conformance that a DOI SEI message with the same value of doi_id and the same payload is present in the layer with layer identifier doi_nuh_layer_id[0].

doi_partition_id[i], when present and doi_partition_type_flag equal to 1, specifies the cr_rect_id[i] of the texture component of the i-th display overlay. doi_partition_id[i], when present and doi_partition_type_flag equal to 0, specifies the subpicture index of the texture component of the i-th display overlay. When not present, the value of doi_partition_id[i] is inferred to be equal to 0.

When doi_partition_type_flag equal to 1, doi_partition_id[i] shall be in the range of 0 . . . cr_num_rects_minus1[doi_nuh_layer_id[i]]−1. When doi_partition_type_flag equal to 0, doi_partition_id[i] shall be in the range of 0 . . . . NumSubpics [doi_nuh_layer_id[i]]−1.

doi_alpha_present_flag[i] equal to 1 specifies that an alpha component is provided for the i-th display overlay. doi_alpha_present_flag[i] equal to 0 specifies that an alpha component is not provided for the i-th display overlay.

doi_alpha_nuh_layer_id[i], when present, specifies the layer identifier value of the alpha component of the i-th display overlay. When not present, the value of doi_alpha_nuh_layer_id[i] is inferred to be equal to the layer identifier of the PU containing the DOI SEI message.

doi_alpha_partition_id[i], when present and doi_partition_type_flag equal to 1, specifies the cr_rect_id[i] of the alpha component of the i-th display overlay. doi_partition_id[i], when present and doi_partition_type_flag equal to 0, specifies the subpicture index of the alpha component of the i-th display overlay. When not present, the value of doi_alpha_partition_id[i] is inferred to be equal to 0.

When doi_partition_type_flag equal to 1, doi_alpha_partition_id[i] shall be in the range of 0 . . . cr_num_rects_minus1[doi_nuh_layer_id[i]]−1. When doi_partition_type_flag equal to 0, doi_alpha_partition_id[i] shall be in the range of 0 . . . . NumSubpics [doi_nuh_layer_id[i]]−1.

doi_top_left_x[i] and doi_top_left_y[i] specify the horizontal and vertical positions, respectively, of the top left corner of the i-th display overlay in the target display picture, in luma samples. When not present, the values of doi_top_left_x[i] and doi_top_left_y[i] are inferred to be equal to 0. The length of the syntax elements is doi_offset_param_length_minus1+1 bits.

doi_width_minus1[i] plus 1 and doi_height_minus1[i] plus 1, when present, specify the width and height, respectively, in luma samples arrays of the i-th display overlay in the target display picture. The length of the syntax elements is doi_size_param_length_minus1+1 bits.

The variables CodedOverlayTexture[i] and CodedOverlayAlpha[i] are picture sample arrays with luma resolution CodedOverlayWidth[i]×CodedOverlayHeight[i], derived as follows:

When doi_pic_partition_flag is equal to 0, the following applies:
CodedOverlayWidth[i] is set equal to PicWidthInLumaSamples[doi_nuh_layer_id[i]]].
CodedOverlayHeight[i] is set equal to PicWidthInLumaSamples[doi_nuh_layer_id[i]].
When there is a picture in the AU for the layer with layer identifier doi_nuh_layer_id[i], CodedOverlayTexture[i] is set equal to the cropped decoded picture from the layer with layer identifier doi_nuh_layer_id[i] in the AU. Otherwise (there is no picture in the AU for the layer with layer identifier doi_nuh_layer_id[i]), CodedOverlayTexture[i] is set equal to the previous cropped decoded picture in output order in the layer with layer identifier doi_nuh_layer_id[i].
When doi_alpha_present_flag[i] equal to 1, the following applies:
   When there is a picture in the AU for the layer with layer identifier doi_alpha_nuh_layer_id[i], CodedOverlayAlpha[i] is set equal to the cropped decoded picture from the layer with layer identifier doi_alpha_nuh_layer_id[i] in the AU.
   Otherwise (there is no picture in the AU for the layer with layer identifier doi_nuh_layer_id[i]), CodedOverlayAlpha[i] is set equal to the previous cropped decoded picture in output order in the layer with layer identifier doi_alpha_nuh_layer_id[i].

Otherwise, when doi_partition_type_flag is equal to 0, the following applies:
CodedOverlayTexture[i] is set equal to the subpicture with subpicture index doi_partition_id[i] from the layer with layer identifier doi_nuh_layer_id[i].
CodedOverlayWidth[i] is set equal to SubPicWidth[doi_nuh_layer_id[i]][doi_partition_id[i]].
CodedOverlayHeight[i] is set equal to SubPicHeight[doi_nuh_layer_id[i]][doi_partition_id[i]].
If doi_alpha_present_flag[i] equal to 0, the following applies:
   CodedOverlayAlphaWidth[i] is set equal to SubPicWidth[doi_alpha_nuh_layer_id[i]][doi_partition_id[i]].
   CodedOverlayAlphaHeight[i] is set equal to SubPicHeight[doi_alpha_nuh_layer_id[i]][doi_partition_id[i]].
   CodedOverlayAlpha[i] is set equal to the subpicture with subpicture index doi_alpha_partition_id[i] from the layer with layer identifier doi_alpha_nuh_layer_id[i].

Otherwise (doi_partition_type_flag is equal to 1), the following applies:
CodedOverlayWidth[i] is set equal to CrWidth[doi_nuh_layer_id[i]][doi_rect_id[i]].
CodedOverlayHeight[i] is set equal to CrHeight[doi_nuh_layer_id[i]][doi_rect_id[i]].
CodedOverlayTexture[i] is set equal to the constituent rectangle with cr_rect_id[j] equal to doi_partition_id[i] from the layer with layer identifier doi_nuh_layer_id[i].
When doi_alpha_present_flag[i] equal to 0
   CodedOverlayAlphaWidth[i] is set equal to CrWidth[doi_alpha_nuh_layer_id[i]][doi_rect_id[i]].
   CodedOverlayAlphaHeight[i] is set equal to CrHeight[doi_alpha_nuh_layer_id[i]][doi_rect_id[i]].
   CodedOverlayAlpha is set equal to the constituent rectangle with cr_rect_id[j] equal to doi_alpha_partition_id[i] from the layer with layer identifier doi_alpha_nuh_layer_id[i].

The variables DisplayOverlayTexture[i] and DisplayOverlayAlpha[i] are sample arrays with luma resolution DisplayOverlayWidth[i]×DisplayOverlayHeight[i], derived as follows:
When doi_resampling_enabled_flag is equal to 1, the following applies:
   DisplayOverlayWidth[i] is set equal to doi_width_minus1[i]+1.
   DisplayOverlayHeight[i] is set equal to doi_height_minus1[i]+1.
OverlayTexture[i] is derived by resampling CodedOverlayTexture[i] from a luma resolution of (CodedOverlayWidth[i]×CodedOverlayHeight[i]) to a luma resolution of (DisplayOverlayWidth[i]×DisplayOverlayHeight[i]).
OverlayAlpha[i] is derived by resampling CodedOverlayAlpha from a luma resolution of (CodedOverlayAlphaWidth[i]×CodedOverlayAlphaHeight[i]) to a luma resolution of (DisplayOverlayWidth[i]×DisplayOverlayHeight[i])
Otherwise (doi_resampling_enabled_flag is equal to 0), the following applies:
DisplayOverlayWidth[i] is set equal to CodedOverlayWidth[i].
DisplayOverlayHeight[i] is set equal to CodedOverlayHeight[i].
OverlayTexture[i] is set equal to CodedOverlayTexture[i].
OverlayAlpha[i] is set equal to CodedOverlay Alpha[i].

The variables TargetPic Width and TargetPicHeight, for the target display picture width and height, respectively, are derived as follows:
TargetPicWidth is set equal to DisplayOverlayWidth[0].
TargetPicHeight is set equal to DisplayOverlayHeight[0].

Let OverlayWithAlpha (tgtPic[x][y], ovlTex[w][h], ovlAlp[w][h]) be specified as a function that returns the sample values derived by applying the alpha channel using tgtPic[x][y] as the background sample, ovlTex[w][h] as the foreground sample, and ovlAlp[w][h] as the alpha channel sample, using the process specified in subclause 8.23 if an alpha channel information SEI message is present in the CVS, or using a process determined via external means.

A target display picture should be formed as follows, with picture array, TargetPicture [cIdx][x][y], with cldx=0 . . . (ChromaFormatIdc==0)?0:2, x=0 . . . (cldx==0)? TargetPicWidth:TargetPicWidth/SubWidthC−1, y=0 . . . (cldx==0)? TargetPicHeight:TargetPicHeight/SubHeightC−1.

```
  for( i = 0; i < doi_num_display_layers_minus2 + 2; i++ ) {
    for( h = 0, y = doi_top_left_y[ i ]; y < DisplayOverlayHeight[ i ]; h++, y++ )
        for( w = 0, x = doi_top_left_x[ i ]; x < DisplayOverlayWidth[ i ]; w++, x++ )
          if( !doi_alpha_present_flag[ i ] )
            TargetPicture[ 0 ][ x ][ y ] = OverlayTexture[ i ][ 0 ][ w ][ h ]
          else
            TargetPicture[ c ][ x ][ y ] = OverlayWithAlpha( TargetPicture[ 0 ][ x ][ y ],
                OverlayTexture[ 0 ][ i ][ w ][ h ], OverlayAlpha[ i ][ w ][ h ] )
  for( ( cIdx = 1; cIdx < ChromaFormatIdc == 0 ) ? 1 : 3; cIdx++ ++ ) {
      for( h = 0, y = doi_top_left_y[ i ]/SubHeightC; y < DisplayOverlayHeight[ i ]/ SubHeightC;
  h++, y++ )
    for( w = 0, x = doi_top_left_x[ i ]/SubWidthC; x < DisplayOverlayWidth[ i ]/ SubWidthC;
  w++, x++ )
              if( !doi_alpha_present_flag[ i ] )
                TargetPicture[ cIdx ][ x ][ y ] = OverlayTexture[ i ][ cIdx ][ w ][ h ]
              else
                TargetPicture[ cIdx ][ x ][ y ] = OverlayWithAlpha( TargetPicture[ cIdx ][ x ][
y ],
                  OverlayTexture[ cIdx ][ i ][ w ][ h ], OverlayAlpha[ i ][ w ][ h ] )
  }
```

### VVC Semantics

For purposes of interpretation of the constituent rectangles SEI message, the following variables are specified:
PicWidthInLumaSamples[i] and PicHeightInLumaSamples[i] are set equal to pps_pic_width_in_luma_samples and pps_pic_height_in_luma_samples, respectively, of the picture with nuh_layer_id equal to i.
NumSubpics [i] is set equal to sps_num_subpics_minus1+1 of the picture with nuh_layer_id equal to i.
SubPicWidth[i][j] is set equal to (sps_subpic_width_minus1[j]+1)*CtbSizeY−1 of the picture with nuh_layer_id equal to i.
SubPicHeight[i][j] is set equal to (sps_subpic_height_minus1[j]+1)*CtbSizeY−1 of the picture with nuh_layer_id equal to i.

It is a requirement of bitstream conformance that there shall be at least one output layer set (OLS) with index olsIdx that has values of OutputLayerIdInOls [olsIdx][j] equal to doi_nuh_layer_id[i] and doi_alpha_nuh_layer_id[i], when present, for each value of i in the range of 0 to doi_num_display_overlays_minus2+1, inclusive, and for any values of j in the range of 0 to NumOutputLayersInOls [olsIdx]−1, inclusive.

### Alternatives

In an alternative embodiment, the target picture width and height dimensions may be explicitly signaled, rather than being derived from the 0-th (base) layer's dimensions. In that case, unlike in the syntax table above, syntax elements describing offsets and resampling are signaled for the 0-th layer, including the doi_top_left_x[i], doi_top_left_y[i], doi_width_minus1[i], and doi_height_minus1[i]. In particular, allowing explicit signaling of the target picture dimensions allows display overlays to be placed in locations where they are not directly overlaid over the base layer picture, but are placed adjacent to it.

### Alternative Embodiment: Usage of Nesting SEI Message(s)

In an alternative embodiment, either or both of layer identifier and partition identifier indications are included in one or more nesting SEI messages that include the DOI SEI message.

For example, the scalable nesting SEI message specified in VVC may be used to indicate the scalability layer(s) and/or the subpicture(s) that the nested DOI SEI message concerns. A scalable nesting SEI message may, for example, include two layers, one for texture video and another for the respective alpha mask, and include a DOI SEI message that applies to both layers.

Alternatively or additionally to the use of the scalable nesting SEI message, the constituent rectangle nesting SEI message may be used to indicate the constituent rectangle(s) that the nested DOI SEI message concerns.

It may be specified that when the DOI SEI message is not nested in a scalable nesting SEI message, it applies to the value of nuh_layer_id of the SEI NAL unit that includes the DOI SEI message.

The value of nuh_layer_id may be associated with an alpha mask auxiliary layer or a primary layer through the SDI SEI message.

Multiple nested DOI SEI messages may be present, each concerning different scalability layer(s), subpicture(s), and/or constituent rectangle(s). When multiple DOI SEI messages are separate constituent rectangle nesting SEI messages in the same picture unit, they shall be present in the same SEI NAL unit and do not cancel the persistence of each other. All DOI SEI messages that concern the output layers of an output layer set are processed collectively when determining the layering order of the display overlays.

An example syntax is presented below:

| | Descriptor |
|---|---|
| display_overlays_info( payloadSize ) { | |
| doi_id | u(6) |
| doi_cancel_flag | u(1) |
| if( !doi_cancel_flag ) { | |
| doi_persistence_flag | u(1) |
| doi_z_order | u(6) |
| doi_offset_params_present_flag | u(1) |
| if( doi_offset_params_present_flag ) { | |
| doi_offset_param_length_minus1 | u(4) |
| doi_top_left_x | u(v) |
| doi_top_left_y | u(v) |
| } | |
| doi_resampling_enabled_flag | u(1) |
| if( doi_resampling_enabled_flag ) | |
| doi_size_param_length_minus1 | u(4) |
| doi_width_minus1 | u(v) |
| doi_height_minus1 | u(v) |
| } | |
| } | |
| } | |

The semantics of the syntax elements are like described above with the addition of:

doi_z_order specifies the front-to-back ordering of display overlays. The display overlay with the greatest value of doi_z_order is the background. The display overlay with doi_z_order value zOrderA is displayed in front of any display overlays with doi_z_order value greater than zOrderA.

### Example Design Discussion

The proposed SEI message design provides flexibility, allowing encoders to decide how to address specific use cases.

Use cases include overlaying logos, onscreen graphics such as scores, or onscreen text such as titles. Another use case is product placement, where a particular product can be replaced without re-encoding the main video. Background replacement is another supported use case.

A display overlay component may be coded as a complete picture, a subpicture, or a constituent rectangle in a single layer or multi-layer CVS.

An encoder for a specific use case may prefer to code multiple display overlay components within a single layer using subpictures or constituent rectangles, for simpler operation by avoiding the need to synchronize decoding of multiple layers.

An encoder for another use cases may prefer using multiple layers for coding of the display overlays, including the alpha component for a particular display overlay in the same layer as its corresponding texture component. The multiple layers would likely be independently coded layers, but the proposed semantics do not impose that restriction.

Use of multiple layers may be used, for example, to separate the 0-th display overlay, e.g., the background display overlay, from the foreground display overlay(s). Coding of the foreground and background as display overlays coded in separate layers enables a media aware network element (MANE) to replace the background without requiring re-encoding of the primary content layer.

Placing display overlay components in separate layers enables different frame rates of overlays, which may help subjective quality by avoiding visible pulsing of static graphic overlays. If the frame rate of one layer is lower than another layer there will be access units containing a picture from some but not all layers. The constituent rectangles for the layer with the missing picture can use the previously decoded picture in output order when forming the target picture.

It may also save bitrate, especially for semi-transparent overlays with dynamic background video.

Using a separate layer for display overlay components also allows encoders the option of using a different chroma format or color space for graphic overlays, for example using RGB 4:4:4 for the graphic overlay while the background video is coded in YUV 4:2:0.

Using separate layers also allows encoders to enable different sets of tools for the different display overlays, e.g. using screen content coding tools for a graphics overlay.

Placing display overlay components in a separate layer enables easier replacement of an individual layer. For example, text overlays such as displayed onscreen titles may be contained in a display overlay in a separate layer than the main video content, allowing replacement of titles for different languages while avoiding the need to re-encode the main video content.

Having display overlays separately available to a video decoder/player enables a variety of use cases, such as reprojection, special effects such as transitions, or enabling/disabling display of individual overlays.

Individual overlay components may be coded with a different effective resolution and resampled, whether the components are encoded in a single layer or multiple layers.

### Summary of Some Example Features

Features of the proposed SEI message are summarized below:

Multiple display overlays are described by the SEI message and are used to form a target display picture.

Each display overlay has a texture component and optionally may have an alpha component.

A display overlay component may be coded as a picture, subpicture, or constituent rectangle, in a single-layer or multiple-layer CVS.

Target display picture display resolution is set to the resolution of the 0-th display overlay.

Display overlays are applied in index order when forming the target display picture.

Display overlays may differ in resolution. The position and size of each display overlay in the target display picture are optionally signaled or derived.

Display overlay components may be resampled when forming the target display picture.

Display overlays coded in separate layers may have different frame rates.

### Further Example Features

Ability to code multiple display overlays in single layer bitstream.

Ability to associate alpha with all display overlays, including the base layer (not supported in HEVC overlay information SEI).

Use of subpictures or constituent rectangles (CRs) for coding display overlays.

Ability to use layer ID in combination with subpictures or CRs to identify display overlays.

Resampling of individual display overlays.

Handling of different frame rates in different layers by repeating previous decoded picture in output order for the CRs from the layer with missing picture when forming the target picture.

### Example Encoder Options:

All display overlay components are coded with the same picture in a single layer.

Using a separate layer for each display overlay, with both the texture and alpha components for that display overlay coded in the same picture.

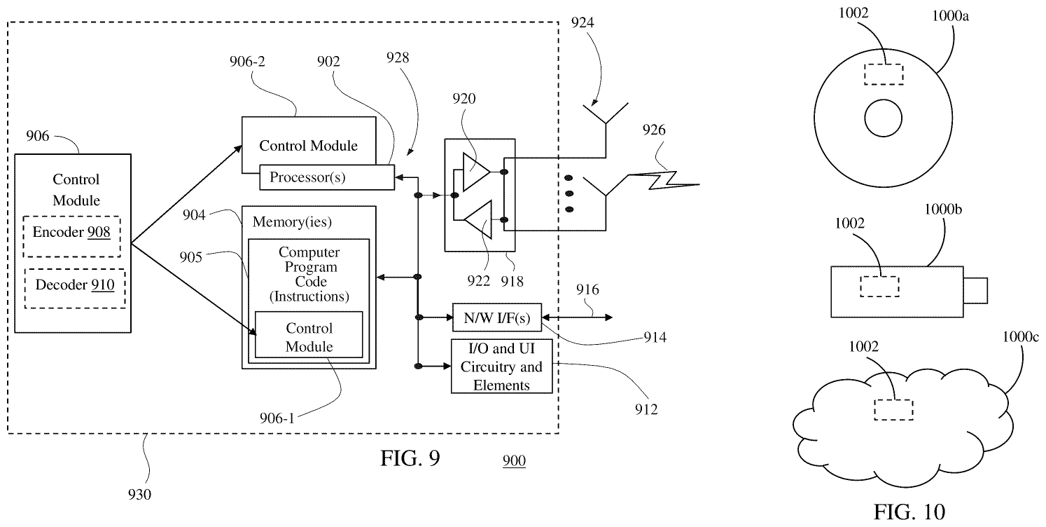

FIG. 9 is an example apparatus 900, which may be implemented in hardware, configured to implement the examples described herein. The apparatus 900 comprises at least one processor 902 (e.g., an FPGA and/or CPU), at least one memory 904 including computer program code 905, the computer program code 905 having instructions to carry out the methods described herein, wherein the at least one memory 904 and the computer program code 905 are configured to, with the at least one processor 902, cause the apparatus 900 to implement circuitry, a process, component, module, or function (implemented with control module 906) to implement the examples described herein, including video coding with display overlays. Optionally included encoder 908 of the control module 906 implements encoding based on the examples described herein, and optionally included decoder 910 implements decoding based on the examples described herein. The at least one memory 904 may be a non-transitory memory, a transitory memory, a volatile memory (e.g., RAM), or a non-volatile memory (e.g., ROM).

The apparatus 900 includes a display and/or I/O interface 912, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 900 includes one or more communication e.g. network (N/W) interfaces (I/F(s)) 914. The communication I/F(s) 914 may be wired and/or wireless and communicate over the Internet/other network(s) via any communication technique including via one or more links 916. The communication I/F(s) 914 may comprise one or more transmitters or one or more receivers.

The transceiver 918 comprises one or more transmitters 920 and one or more receivers 922. The transceiver 918 and/or communication I/F(s) 914 may comprise standard well-known components such as an amplifier, filter, frequency-converter, (de) modulator, and encoder/decoder circuitries and one or more antennas, such as antennas 924 used for communication over wireless link 926.

The control module 906 of the apparatus 900 comprises one of or both parts 906-1 and/or 906-2, which may be implemented in a number of ways. The control module 906 may be implemented in hardware as control module 906-1, such as being implemented as part of the at least one processor 902. The control module 906-1 may be implemented also as an integrated circuit or through other hardware such as a programmable gate array. In another example, the control module 906 may be implemented as control module 906-2, which is implemented as computer program code (having corresponding instructions) 905 and is executed by the at least one processor 902. For instance, the at least one memory 904 store instructions that, when executed by the at least one processor 902, cause the apparatus 900 to perform one or more of the operations as described herein. Furthermore, the at least one processor 902, the at least one memory 904, and example algorithms (e.g., as flowcharts and/or signaling diagrams), encoded as instructions, programs, or code, are means for causing performance of the operations described herein.

The apparatus 900 to implement the functionality of control module 906 may correspond to any of the apparatuses depicted herein. Alternatively, apparatus 900 and its elements may not correspond to any of the other apparatuses depicted herein, as apparatus 900 may be part of a self-organizing/optimizing network (SON) node or other node, such as a node in a cloud.

The apparatus 900 may also be distributed throughout the network including within and between apparatus 900 and any network element (such as a base station and/or terminal device and/or user equipment).

Interface 928 enables data communication and signaling between the various items of apparatus 900, as shown in FIG. 9. For example, the interface 928 may be one or more buses such as address, data, or control buses, and may include any interconnection mechanism, such as a series of lines on a motherboard or integrated circuit, fiber optics or other optical communication equipment, and the like. Computer program code (e.g. instructions) 905, including control module 906 may comprise object-oriented software configured to pass data or messages between objects within computer program code 905. The apparatus 900 need not comprise each of the features mentioned, or may comprise other features as well. The various components of apparatus 900 may at least partially reside in a housing 930, or a subset of the various components of apparatus 900 may at least partially be located in different housings, which different housings may include housing 930.

FIG. 10 shows a schematic representation of non-volatile memory media 1000a (e.g. computer/compact disc (CD) or digital versatile disc (DVD)) and 1000b (e.g. universal serial bus (USB) memory stick) and 1000c (e.g. cloud storage for downloading instructions and/or parameters 1002 or receiving emailed instructions and/or parameters 1002) storing instructions and/or parameters 1002 which when executed by a processor allows the processor to perform one or more of the operations of the methods described herein. Instructions and/or parameters 1002 may represent or correspond to a non-transitory computer readable medium.

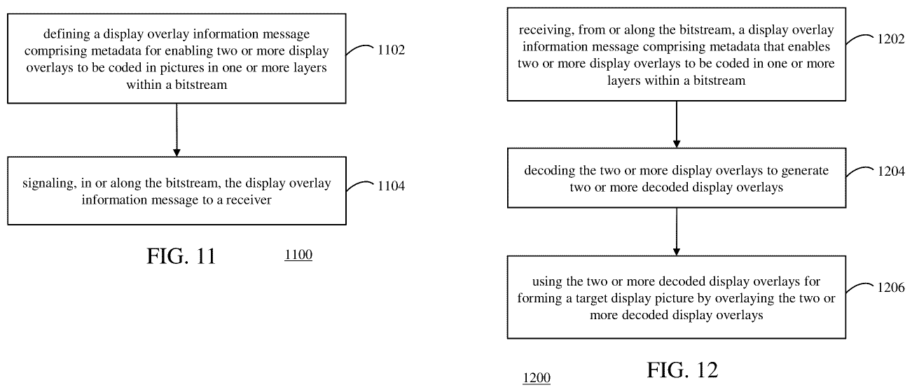

FIG. 11 is an example method 1100 performed with an encoder, based on the examples described herein. At 1102, the method 1100 includes defining a display overlay information message comprising metadata for enabling two or more display overlays to be coded in pictures in one or more layers within a bitstream. At 1104, the method 1100 includes signaling, in or along the bitstream, the display overlay information message to a receiver.

In an embodiment, the metadata comprised in the display overlay information message is intended to be used by the receiver to form a target display picture comprising two or more display overlays in a specified order.

In an embodiment, one or more higher order display overlays are displayed in front of one or more lower order display overlays. In an example, one or more higher order displays are one or more displays with higher order, and one or more lower order displays are one or more displays with lower order.

The method 1100 may be performed with an encoding apparatus, such as the apparatus 100, 900, apparatuses depicted in FIG. 3 and FIG. 4, for example, the transmitting apparatus 406 with the encoder 402, or the apparatus 400 with the encoder 402.

FIG. 12 is an example method 1200 performed with a decoder, based on the example embodiments described herein. At 1202, the method 1200 includes receiving, from or along the bitstream, a display overlay information message comprising metadata that enables two or more display overlays to be coded in one or more layers within a bitstream. At 1204, the method 1200 includes decoding the two or more display overlays to generate two or more decoded display overlays. At 1206, the method 1200 includes using the two or more decoded display overlays for forming a target display picture by overlaying the two or more decoded display overlays.

In an embodiment, the target display picture comprises a composite formed by applying the two or more decoded display overlays in a specified order.

In an embodiment, one or more higher order display overlays are displayed in front of one or more lower order display overlays. In an example, one or more higher order displays are one or more displays with higher order, and one or more lower order displays are one or more displays with lower order.

The method 1200 may be performed with a decoding apparatus, such as the apparatus 100, 900, apparatuses depicted in FIG. 3 and FIG. 4, for example, the receiving apparatus 410 with the decoder 412, or the apparatus 400 with the decoder 412.

As described above, FIGS. 11 and 12 include flowcharts of an apparatus (e.g. 100, 400, 900, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 112 or 904) of an apparatus employing an embodiment of the present invention and executed by processing circuitry (e.g., 110 or 902) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 11 and 12. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some embodiments have been described with reference to SEI messages. It needs to be understood that embodiments may be similarly realized with any other similar syntax structures, such as metadata OBUs or registered ITU-T T.35 metadata.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, some embodiments have been described in relation to particular syntax elements and/or syntax structures. It needs to be understood that corresponding embodiments for encoding may be realized by including encoding steps for creating the particular syntax elements and/or syntax structures. Similarly, it needs to be understood that corresponding embodiments for decoding may be realized by including decoding steps for reading the particular syntax elements and/or syntax structures. Furthermore, when the decoded syntax elements and/or syntax structures imply certain processing, such as certain processing order of SEI messages, corresponding embodiments for decoding may include such processing steps.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to:
defining a display overlay information message comprising metadata for enabling two or more display overlays to be coded in pictures in one or more layers within a bitstream; and
signaling, in or along the bitstream, the display overlay information message to a receiver.

2. The apparatus of claim 1, wherein one or more higher order display overlays are displayed in front of one or more lower order display overlays.

3. The apparatus of claim 2, wherein when an alpha component is present for a display overlay, the alpha component is applied to a higher order display overlay pixel values, with an existing target display picture as the background, to form new pixel values in a target display picture.

4. The apparatus of claim 1, wherein the instructions, when executed by the at least one processor, cause the apparatus at least to perform: signaling first syntax elements to determine which of pictures, subpictures, or constituent rectangles are used for coding the two or more display overlays.

5. The apparatus of claim 1, wherein the instructions, when executed by the at least one processor, cause the apparatus at least to perform:
defining second syntax elements for identifying a location of each display overlay component in the bitstream and an intended display order of the each display overlay in a target display picture; and
signaling, in or along the bitstream, the second syntax elements to the receiver.

6. The apparatus of claim 2, wherein the instructions, when executed by the at least one processor, cause the apparatus at least to perform: signaling, in or along the bitstream, position of the each display overlay in a target display picture.

7. The apparatus of claim 2, wherein the instructions, when executed by the at least one processor, cause the apparatus at least to perform: signaling, in or along the bitstream, a resampling ratio for at least one display overlay, wherein the resampling ratio is used by the receiver to derive a size of the at least one display overlay in a target display picture.

8. The apparatus of claim 1, wherein the two or more display overlays coded in separate layers comprise different frame rates.

9. An apparatus comprising:
at least one processor; and
at least one memory storing instructions that, when executed by the at least one processor, cause the apparatus at least to:
receiving, from or along a bitstream, a display overlay information message comprising metadata that enables two or more display overlays to be coded in one or more layers within the bitstream;
decoding the two or more display overlays to generate two or more decoded display overlays; and
using the two or more decoded display overlays for forming a target display picture by overlaying the two or more decoded display overlays.

10. The apparatus of claim 9, wherein one or more higher order display overlays are displayed in front of one or more lower order display overlays.

11. The apparatus of claim 10, wherein when an alpha component is present for a display overlay, new pixel values in the target display picture are formed by applying the alpha component to a higher order display overlay pixel values with an existing target display picture as the background.

12. The apparatus of claim 9, wherein the instructions, when executed by the at least one processor, cause the apparatus at least to perform: receiving first syntax elements to determine which of pictures, subpictures, or constituent rectangles were used to code the two or more display overlays.

13. The apparatus of claim 12, wherein the instructions, when executed by the at least one processor, cause the apparatus at least to perform one of the following:
using a layer identifier in combination with the subpictures or the constituent rectangles for identifying the two or more display overlays;
using the layer identifier for identifying the two or more display overlays;
using subpicture parameters to identify the two or more display overlays; or
using constituent rectangle parameters for identifying the two or more display overlays.

14. The apparatus of claim 9, wherein the instructions, when executed by the at least one processor, cause the apparatus at least to perform: receiving, from or along the bitstream, second syntax elements for identifying a location of each display overlay component in the bitstream and an intended display order of the each display overlay in the target display picture.

15. The apparatus of claim 10, wherein the instructions, when executed by the at least one processor, cause the apparatus at least to perform: receiving, from or along the bitstream, position of the each display overlay in the target display picture.

16. The apparatus of claim 2, wherein the instructions, when executed by the at least one processor, cause the apparatus at least to perform:
receiving, from or along the bitstream, a resampling ratio for at least one display overlay; and
using the resampling ratio for determining or deriving a size of the at least one display overlay in a target display picture.

17. The apparatus of claim 16, wherein the size of the at least one display overlay is determined or derived based on one of the following:
a picture height and width;
a subpicture height and width; or
a constituent rectangle height and width.

18. The apparatus of claim 9, wherein the two or more display overlays coded in separate layers comprise different frame rates.

19. A method comprising:
defining a display overlay information message comprising metadata for enabling two or more display overlays to be coded in pictures in one or more layers within a bitstream; and
signaling, in or along the bitstream, the display overlay information message to a receiver.

20. A method comprising:
receiving, from or along a bitstream, a display overlay information message comprising metadata that enables two or more display overlays to be coded in one or more layers within the bitstream;
decoding the two or more display overlays to generate two or more decoded display overlays; and
using the two or more decoded display overlays for forming a target display picture by overlaying the two or more decoded display overlays.
